(19) United States
(12) Patent Application Publication
(10) Pub. No.: US 2016/0128312 A1
(43) Pub. Date: May 12, 2016

(54) CARRYING CASE FOR ICE FISHING RODS AND TIP UPS

(71) Applicant: Luke Siebert, Gladstone, MI (US)

(72) Inventor: Luke Siebert, Gladstone, MI (US)

(21) Appl. No.: 14/558,198

(22) Filed: Dec. 2, 2014

Related U.S. Application Data
(60) Provisional application No. 62/077,605, filed on Nov. 10, 2014.

(51) Int. Cl. A01K 97/08; A01K 97/01; A45C 13/30; A01K 97/06; A45C 13/10; A45C 13/26

(52) U.S. Cl. CPC A01K 97/08; A45C 13/103; A45C 13/26; A45C 13/30; A01K 97/06; A01K 97/01

(57) ABSTRACT

A carrying case for ice fishing equipment allows a user to combine tip ups and fishing rods and reels in the most efficient manner. One example carrying case can be carried upon the user's back. The example carrying case has a first compartment that has a plurality of rod and reel sections, each sized to accommodate a fishing rod and reel. Each of the first sections has a first length and a first thickness along a first portion of the first length, where the first portion accommodates at least some of the rod. The example carrying case has a plurality of tip up sections each sized to accommodate a tip up. Each of the second sections has a second length shorter than the first length. Each of the second sections has a second thickness along the second length. Each of the first sections have a third thickness that is greater than the first thickness being along a second portion of the first length that corresponds to a difference between the first length and the second length. The second portion is adjacent to one end of the second compartment.

### FIELD OF THE INVENTION

This disclosure relates to a carrying case for ice fishing equipment such as rods, reels, and tip ups, and includes as part of the construction compartments and sections for receiving various items of fishing equipment.

### BACKGROUND

Fishing rods and reels along with tip ups are commonly used in the sport of ice fishing. It is beneficial to an angler to be able to set up a number of tip ups on the ice within viewing distance, while being able to sit over a hole with a fishing rod. The increased numbers of lines in the water increases the likelihood that the angler will hook a fish. Anglers must be able to carry the combination of fishing rods and tip ups in one efficient case. In addition to being able to carry fishing equipment in an efficient manner it is also, if not more important to be able to safely store very expensive, and often times handmade, fishing equipment without fear of damaging equipment.

It has been proposed in U.S. Pat. No. 5,042,193 to create a carrying case made specifically for carrying tip ups and small ice fishing tackle items and a jig pole. One of the primary purposes of this carrying case is to hold the ice fishing tip ups and rods and reels within separate compartments and keep them relatively immobile during transportation. Moreover, another purpose of this case is to provide a case that allows the user to package a number of rod and reels along with a number of tip ups, all while using the space in an efficient manner.

### SUMMARY

A carrying case for ice fishing equipment allows a user to combine tip ups and fishing rods and reels in the most efficient manner. One example carrying case can be carried upon the user's back. The example carrying case has a first compartment that has a plurality of rod and reel sections, each sized to accommodate a fishing rod and reel. Each of the first sections have a first length and a first thickness along a first portion of the first length, where the first portion accommodates at least some of the rod. The example carrying case has a plurality of tip up sections each sized to accommodate a tip up. Each of the second sections has a second length shorter than the first length. Each of the second sections has a second thickness along the second length. Each of the first sections have a third thickness that is greater than the first thickness being along a second portion of the first length that corresponds to a difference between the first length and the second length. The second portion is adjacent to one end of the second compartment.

### BRIEF DESCRIPTION OF THE DRAWINGS

The disclosure can be further understood by reference to the following detailed description when considered in connection with the accompanying drawings wherein:

FIG. 1 is a perspective view of an example carrying case for ice fishing equipment;

FIG. 2 is an exploded view of the carrying case;

FIG. 3 is a cross-sectional view taken along the line 3-3;

FIG. 4 is a top view of an insert;

FIG. 5A is a top view of the second compartment;

FIG. 5B is an alternative configuration of a top view of the second compartment of FIG. 5A; and

FIG. 6 is a front elevation view of the carrying case.

### DETAILED DESCRIPTION

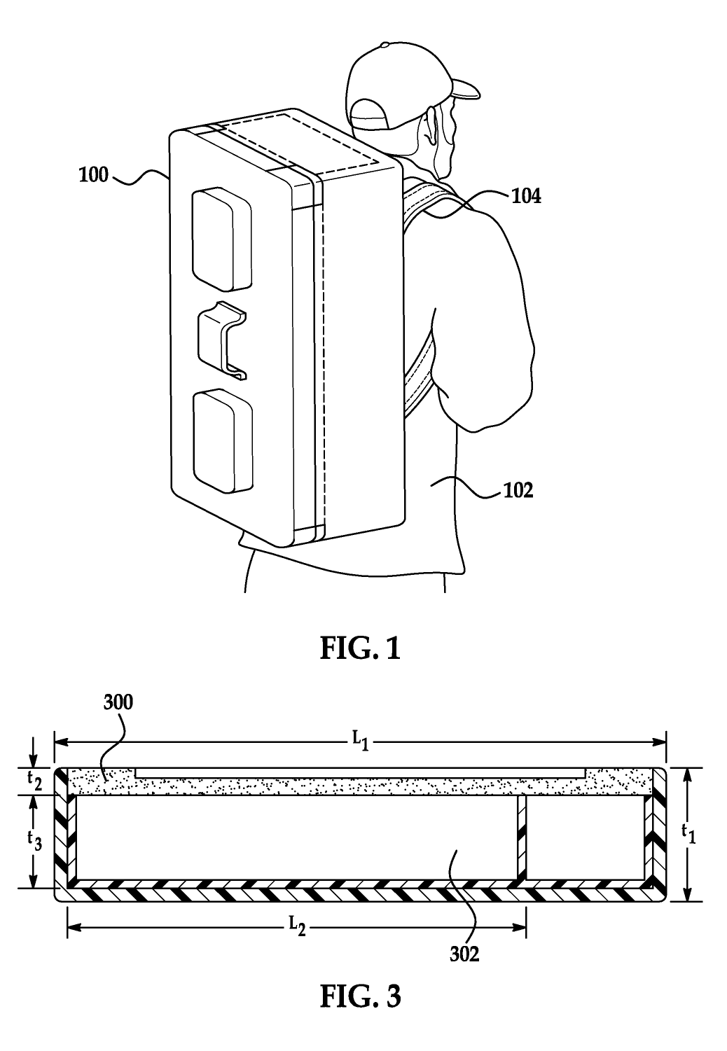

FIG. 1 illustrates a carrying case for ice fishing rods and reels and tip ups. In the illustrated example, the carrying case 100 includes a carrying strap 104 to allow a user to place one strap 104 over the user's 102 shoulders

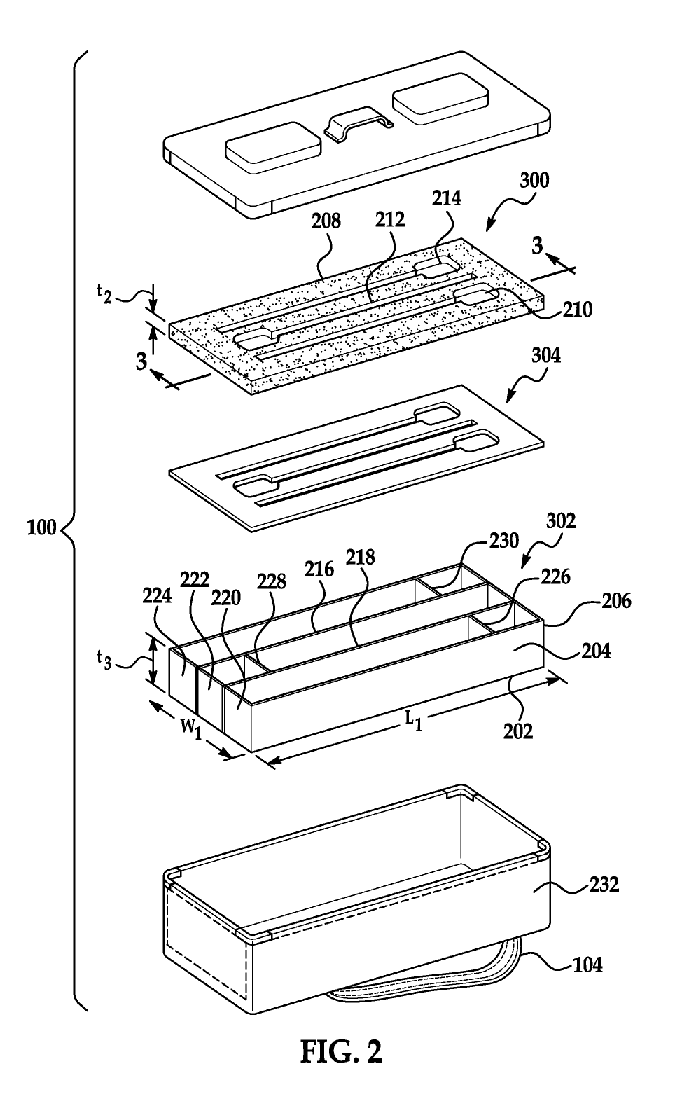

FIG. 2 is an exploded view of the carrying case 100. As shown, the carrying case 100 has a base 202, having a length of L₁ and a width of W₁. Sidewalls 204, having a length L₁ and thickness T₁ are vertically arranged and adjacent to the base 202. Two end walls 206 and the base are adjacent to the sidewalls 204. The end wall has a width W₁ and a thickness T₁. The end walls 206 are not continuous but have openings or slots to allow sliding in a tip up.

The case includes two compartments, a first compartment 300 and a second compartment 302 adjacent the first compartment 300. In FIGS. 2 and 3, the compartments 300 and 302 are shown “above” and “below” each other, but that is not intended to be limiting.

The first compartment 300 includes an insert 208 with a plurality of sections with recesses, 210, 212, and 214 having a shape and size corresponding to ice fishing rods and reels. In one example, the insert is made of foam. While in this example there are three recesses, other carrying cases can be provided with a different number of recesses.

The second compartment 302 includes two tip up dividing walls, 216 and 218, that establish a plurality of sections 220, 222, and 224. In this example, there are three sections. Each section includes one stopper wall 226, 228, and 230, respectively. The stopper walls 226, 228, and 230 are spaced away from the end walls 206 corresponding to the length of a tip up. In one example, the two dividing walls 216 and 218 and the stopper walls 226, 228, and 230 are molded from a single piece of plastic that is inserted into the frame established by the base 202, sidewalls 204 and end walls 206. While in this example there are two tip up dividing walls 216 and 218 and the stopper walls 226, 228, and 230 are molded from a single piece of plastic, this disclosure extends to carrying cases with a different number of dividing and stopper walls that are made from several pieces of plastic which are assembled together. Shown beneath the second compartment 302 is a cover 232. In one example, the cover is made from a durable and waterproof nylon material.

In an alternative embodiment a rod and reel reinforcement 304 may be utilized to provide stability to the first compartment.

Referring to FIG. 3, a cross sectional view along the length of the carrying case is illustrated. FIG. 3 illustrates features of a relationship between the dimensions or configuration of the first compartment 300 and the second compartment 302.

The carrying case has two compartments, a first compartment 300 and a second compartment 302. The first compartment 300 has an overall length of L₁ and the second compartment 302 has an overall length of L₂. The first compartment 300 has three sections 210, 212, and 214. The length of the three sections 210, 212, and 214 is defined as approximately L₁. The thickness of the three sections 210, 212, and 214 has a thickness T₁. The second has a length as defined as L₂ and a variable thickness of either T₁ and T₂.

The first compartment 300 and second compartment 302 are arranged in a manner that provides for an efficient use of space. The first compartment 300 has a substantially L shaped cross section. The thickest portion of the L is received against one side of the second compartment 302. The arrangement as best shown in FIG. 3, allows the rod portion, to sit within the vacant space.

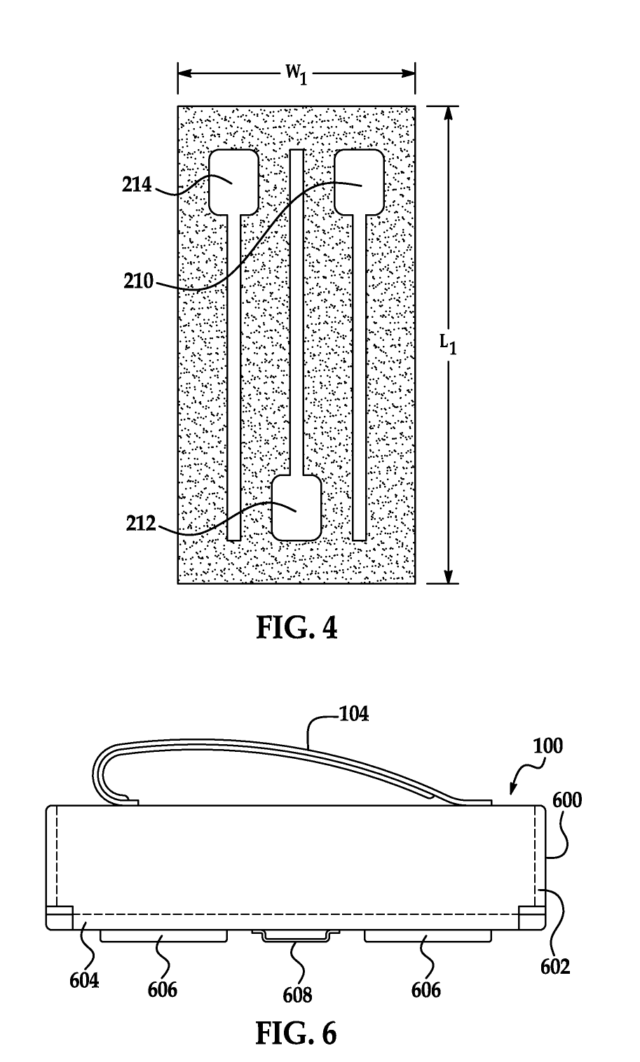

FIG. 4 is a top view of the example insert 208. In this example, the material of the foam insert is made of foam soft enough to deform and allow for a press fit for the rods and reels while being durable allowing for repeatedly inserting and removing of the rod and reels. The recesses 210, 212, and 214 are oriented to have the tip of the rods and one reel of another to be adjacent to each other, thus for allowing efficient use of space. The rod portion of the fishing rod and reel is the thinnest portion of the rod and reel combo. Conversely, the reel portion of the fishing rod and reel assembly is the thickets portion of the rod and reel assembly. Placing the rod adjacent to another reel allows for a horizontally narrow arrangement of the fishing rod and reels.

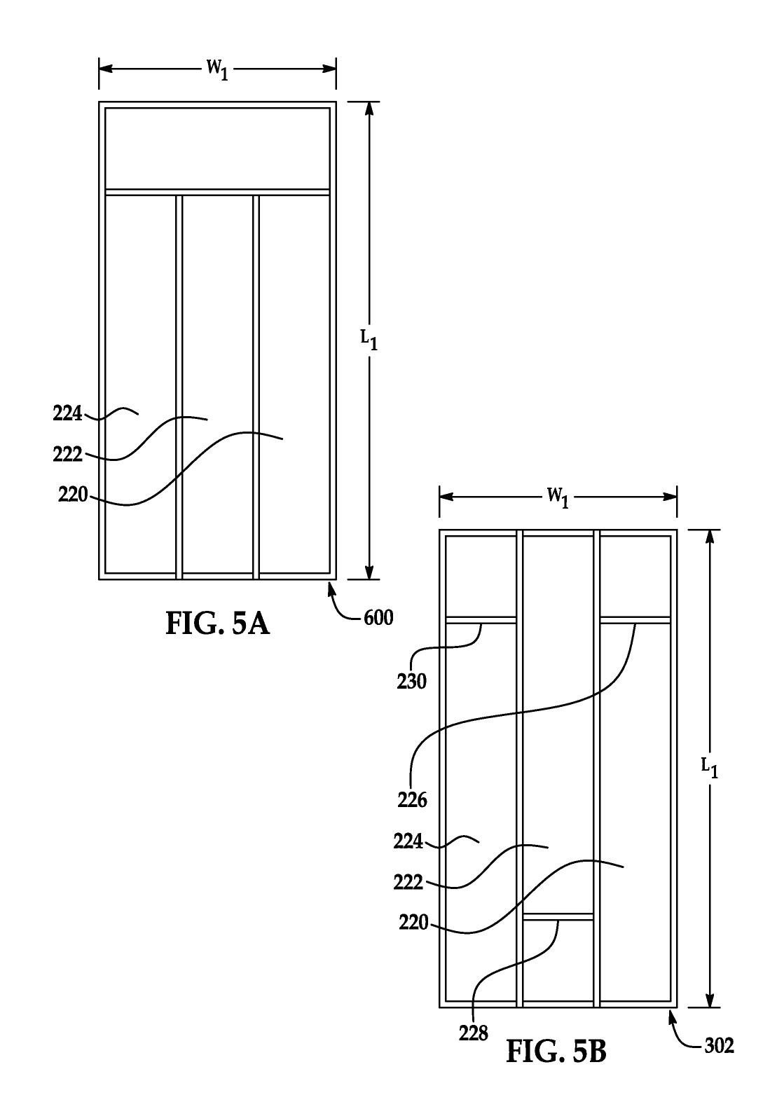

FIG. 5A is a top view of the second compartment 202. The three sections 320, 322, and 324 are aligned with the recesses 310, 312, and 314 as shown in FIG. 4. The two outer sections allow for the placement of a tip up from the opening 600. Each section includes one stopper wall 226, 228, and 230, respectively. The stopper wall 230 is spaced away from the end walls 206 corresponding to the length of a tip up. Although not shown, there could be a third tip up placed in the center section from an opening from the opposite side.

FIG. 5B is a top view of the second compartment 202 in an alternative embodiment to FIG. 5A. The three sections 320, 322, and 324 are aligned with the recesses 310, 312, and 314 as shown in FIG. 4. The two outer sections allow for the placement of a tip up from the opening 600. Each section includes one stopper wall 226, 228, and 230, respectively. The stopper walls 226, 228, and 230 are spaced away from the end walls 206 corresponding to the length of a tip up. In one example, the two dividing walls 216 and 218 and the stopper walls 226, 228, and 230 are molded from a single piece of plastic that is inserted into the frame established by the base 202, sidewalls 204 and end walls 206. Although not shown, there could be a third tip up placed in the center section from an opening from the opposite side.

FIG. 6 is a front elevation view of the carrying case 100. In one example, a front opening zipper 602 is situated around the periphery of the carrying case 100 near at least one of the end walls 306. Additionally, a top zipper 604 is situated around the periphery of the carrying case near the top first compartment 200. A strap 104 is connected on the back of the carrying case 100. Opposite to the back of the carrying case are two pockets 606 capable of storing miscellaneous tackle gear. Situated between the pockets 606 is a handle 608.

The dimensions L₁, L₂, W₁, W₂, T₁, T₂, and T₃ are unit-less dimensions, sized to accommodate a fishing rod and reel and tip ups.

This description is not intended to be limiting and variations or modifications may become apparent to those skilled in the art.

1. A carrying case for ice fishing equipment comprising:
a first compartment having a plurality of rod and reel sections each sized to accommodate a fishing rod and reel, each of the rod and reel sections having a first length and a first thickness along a first portion of the first length, where the first portion accommodates at least some of a rod; and
a second compartment having a plurality of tip up sections each sized to accommodate a tip up, each of the tip up sections having a second length shorter than the first length, each of the tip up sections having a second thickness along the second length, each of the rod and reel sections having a third thickness greater than the first thickness, the third thickness being along a second portion of the first length corresponding to a difference between the first length and the second length, the second portion being adjacent one end of one of the second compartment.

2. The carrying case of claim 1, wherein the first and second compartments are composed of a base, side walls, and end walls.

3. The carrying case of claim 1, wherein the first and second compartments are enclosed by a cover.

4. The carrying case of claim 3, wherein the cover is made of fabric.

5. The carrying case of claim 3, wherein the cover includes a flap selectively detachable from a remainder of the cover.

6. The carrying case of claim 5, wherein the flap is adjacent the end of an opening side.

7. The carrying case of claim 3, wherein the cover has a plurality of pockets.

8. The carrying case of claim 7, wherein the plurality of pockets have a zipper allowing opening of the pockets.

9. The carrying case of claim 1, wherein the second length at least partially overlaps a third length.

10. The carrying case of claim 1, wherein the second compartment has a first section, a second section and a third section.

11. The carrying case of claim 10, wherein the first and third sections are adjacent to the sidewalls, and the second section is adjacent to the first and third sections,

12. The carrying case of claim 11, wherein third thickness of the first and third sections are aligned opposite from the second section.

13. The carrying case of claim 1, wherein the first compartment has a first section, a second section, and a third section.

14. The carrying case of claim 13, wherein the first and third second sections are adjacent to the sidewalls, and the second section is adjacent to the first and third sections.

15. The carrying case of claim 14, wherein the sections are vertically aligned with the second length.

16. The carrying case of claim 15, wherein the tip up sections allow for placement of a tip up therein.

17. The carrying case of claim 14, wherein the rod and reel sections allow for placement of a rod and reel therein.

18. The carrying case of claim further comprising a strap detachably attached to the cover.

19. The carrying case of claim further comprising a handle detachably attached to the cover.

20. The carrying case of claim further comprising a zipper allowing for an opening of at least one of a side and a top of the carrying case.
